(19) United States
(12) Patent Application Publication
(10) Pub. No.: US 2023/0057362 A1
(43) Pub. Date: Feb. 23, 2023

(54) BEVERAGE CONTAINER RECYCLING SYSTEM

(71) Applicant: Olyns, Inc., Los Gatos, CA (US)

(72) Inventors: Philip Stanger, Los Gatos, CA (US); John Buchowski, Los Gatos, CA (US)

(21) Appl. No.: 17/820,927

(22) Filed: Aug. 19, 2022

Related U.S. Application Data
(60) Provisional application No. 63/235,608, filed on Aug. 20, 2021.

(51) Int. Cl. G07F 7/06; B30B 9/32; G07F 9/00

(52) U.S. Cl. CPC G07F 7/0609; B30B 9/325; G07F 9/002

(57) ABSTRACT

A beverage container recycling system has a housing with an advertising display, a user feedback display and a deposit opening. An imaging region is connected to the deposit opening. The imaging region has a camera to take an image of a deposited beverage container. A processor, network interface circuit and memory are associated with the housing. The memory stores instructions executed by the processor to analyze the image of the deposited beverage container to characterize the deposited beverage container as one of glass, aluminum or plastic. A carriage directly deposits a glass beverage container in a glass bin. The carriage directs aluminum and plastic beverage containers to a crusher with a blade to pierce aluminum and plastic beverage containers prior to compaction. The crusher selectively directs compacted beverage containers to a plastic bin and an aluminum bin. The memory stores instructions executed by the processor to maintain a count of deposited beverage containers and communicates the count of deposited beverage containers to the network interface circuit for routing to a networked machine.

### CROSS-REFERENCE TO RELATED APPLICATION

This application claims priority to U.S. Provisional Patent Application Ser. No. 63/235,608, filed Aug. 20, 2021, the contents of which are incorporated herein by reference.

### FIELD OF THE INVENTION

This invention relates generally to recycling of single use beverage containers. More particularly, this invention is directed toward a beverage container recycling system operative in a computer network.

### BACKGROUND OF THE INVENTION

The recycling system for beverage containers is broken. Even in “bottle bill” states, such as California, recycling rates for plastic bottles are declining. Forty states have no “bottle bills”, resulting in recycling rates sometimes below 1%. The resulting environmental damage has been highly publicized.

Against this backdrop of poor and decreasing diversion rates, consumer brands are responding to public outcry and are making public pledges to use more recycled plastic in their containers. In the most recent Ellen MacArthur Foundation survey, the top beverage brands made commitments that require ten times more uncontaminated recyclable feedstock than is available today. This leaves a massive discrepancy with no current solution.

### SUMMARY OF THE INVENTION

A beverage container recycling system has a housing with an advertising display, a user feedback display and a deposit opening. An imaging region is connected to the deposit opening. The imaging region has a camera to take an image of a deposited beverage container. A processor, network interface circuit and memory are associated with the housing. The memory stores instructions executed by the processor to analyze the image of the deposited beverage container to characterize the deposited beverage container as one of glass, aluminum or plastic. A carriage directly deposits a glass beverage container in a glass bin. The carriage directs aluminum and plastic beverage containers to a crusher with a blade to pierce aluminum and plastic beverage containers prior to compaction. The crusher selectively directs compacted beverage containers to a plastic bin and an aluminum bin. The memory stores instructions executed by the processor to maintain a count of deposited beverage containers and communicates the count of deposited beverage containers to the network interface circuit for routing to a networked machine.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates a collector machine configured in accordance with an embodiment of the invention.

FIG. 3 illustrates a rear view of the collector machine.

FIG. 4 illustrates a rear view of the collector machine.

FIG. 5 is a top view of the crusher within the collector machine.

FIG. 6 is a rear view of the crusher within the collector machine.

FIG. 7 is a user interface associated with a user module.

FIG. 8 is a user interface showing collector locations

FIG. 9 is a user interface showing user environmental impact data.

FIG. 10 is a user interface showing a user's competitive standing.

FIGS. 11-14 show user interfaces for enrolling a service provider.

FIGS. 15-17 show user interfaces for soliciting a service provider task.

FIGS. 18-19 show user interfaces for directing a service provider to empty a collector machine.

FIGS. 20-21 show user interfaces with transport instructions.

FIGS. 22-24 show user interfaces documenting delivery completion.

Like reference numerals refer to corresponding parts throughout the several views of the drawings.

### DETAILED DESCRIPTION OF THE INVENTION

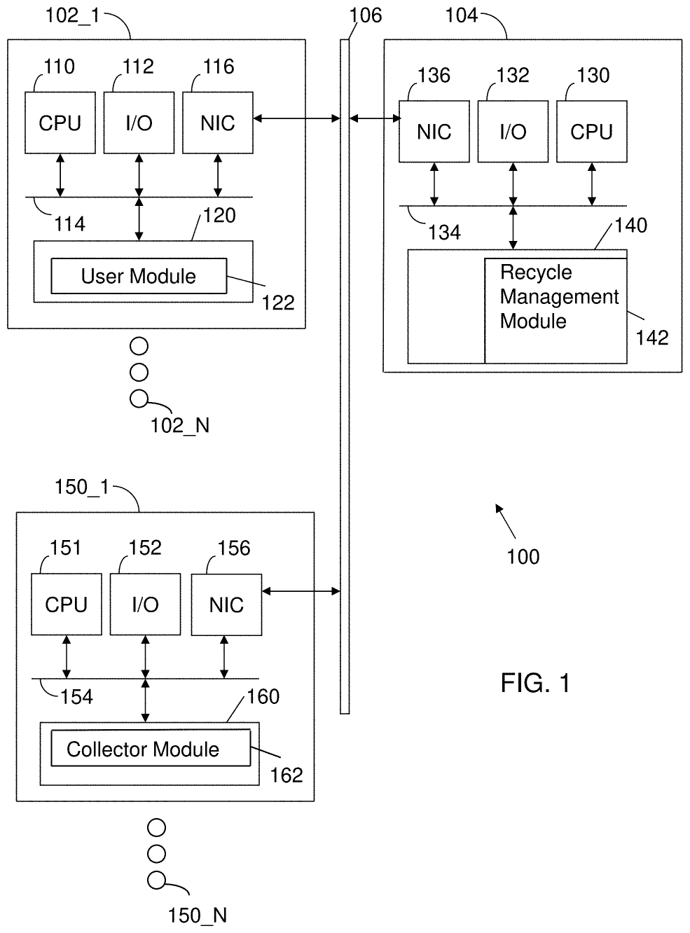

FIG. 1 illustrates a system 100 configured in accordance with an embodiment of the invention. The system 100 includes user machines 102_1 through 102_N (e.g., smartphones) in communication with a server 104 (e.g., a cloud resource) via a network 106, which may be any combination of wired and wireless networks. Client machine 102_1 includes a processor 110 and input/output devices 112 connected via a bus 114. The input/output devices 112 may include a keyboard, mouse, touch display and the like. A network interface circuit 116 is also connected to the bus 114. The network interface circuit 116 provides connectivity to network 106. A memory 120 is also connected to the bus 114. The memory 120 stores a user module 122 with instructions executed by processor 110 to implement user or client operations discussed below. User machine 102_1 may be a desktop computer, laptop computer, tablet, smartphone, wearable device and the like.

Server 104 includes a processor 130, input/output devices 132, a bus 134 and a network interface circuit 136. A memory 140 is connected to bus 134. The memory 140 stores a recycle management module 142 with instructions executed by processor 130 to implement recycle tracking operations as detailed below.

The system 100 also includes beverage container collector machines 150_1 through 150_N in communication with network 106. Beverage container collector machine 150_1 includes a processor, input/output devices 152, a bus 154 and a network interface circuit 156. A memory 160 is connected to bus 154. The memory 160 stores a collector module 162 with instructions executed by processor 151 to implement operations performed by the collector and to report information to server 104.

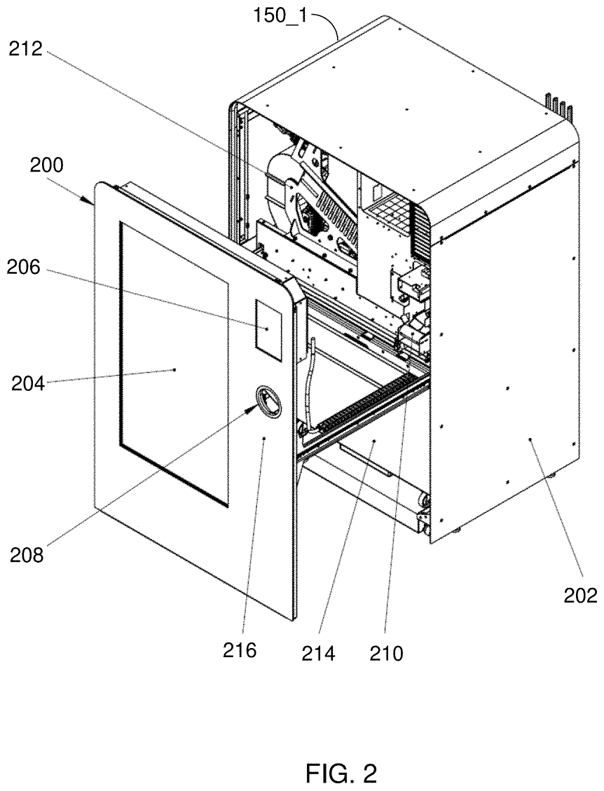

FIG. 2 illustrates a beverage container recycling collector 150_1 configured in accordance with an embodiment of the invention. The collector 150_1 receives deposits of single use plastic, aluminum and glass beverage containers. The collector 150_1 sorts, crushes and maintains counts of such containers. Beverage container counts are sent to server 104 via network 106.

In one embodiment, the collector 150_1 occupies the same floor area as a traditional vending machine—being roughly 3′ in depth, 4′ in width, and 6′ in height. The front panel 200 is a single sheet of mar resistant acrylic. The sides 202 are covered in a vandalism resistant aluminum skin. The collector 150_1 is designed for use indoors and outdoors.

A primary display 204 may host one or more advertisements. A user feedback display 206 provides instructions to a user. The machine includes a beverage container deposit opening 208, which leads to an imager and material transport system 210. The imager captures a picture of the user deposit and classifies it, as discussed below. The material transport system 210 moves aluminum and plastic containers to a crusher 212. Glass containers are immediately directed to storage bin 214 and crushed aluminum and plastic containers are placed in storage bin 214. Region 216 incorporate a Near Field Communication (NFC) reader.

User machine 102_1 installs a user module 122 (e.g., a client-side application) to utilize the system. When a user approaches collector 150_1, the user swipes machine 102_1 in front of the NFC reader 216 to sign in. Users can confirm they are signed in with visual feedback provided on the small deposit screen 206. Once signed in, users place their deposits into the deposit opening 208. The deposit opening 208 provides visual feedback to users by lighting up and indicating that the system is ready to accept deposits (e.g., green), is working (e.g., red), or is idle (e.g., blue and green rotating display).

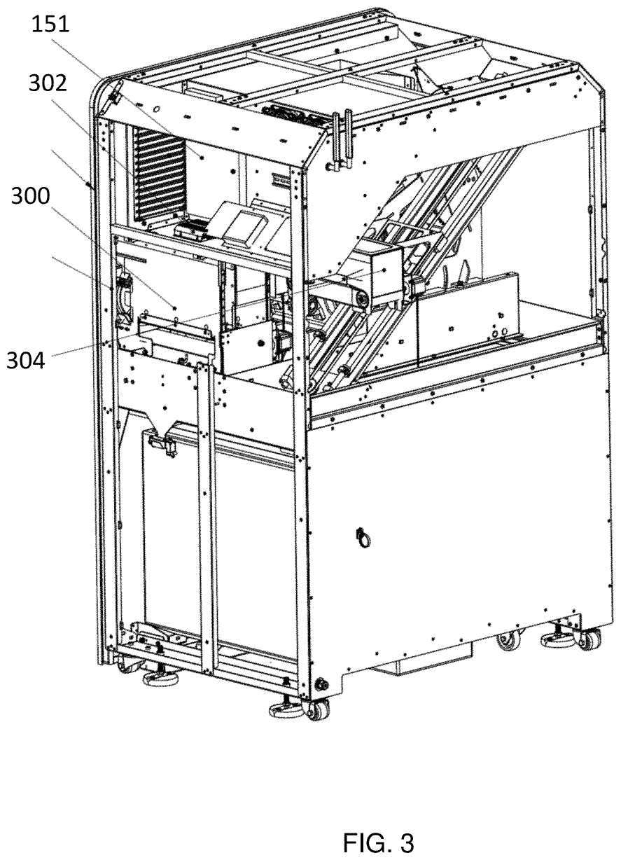

FIG. 3 illustrates collector 150_1 with skin 202 removed. An imager 300 includes a scale to weigh each deposit. A camera 302 captures an image of a deposit. A processor 151 executes instructions associated with the collector module 162 to develop a characterization of the deposit. In one embodiment, the collector module 162 uses artificial intelligence image recognition processing techniques. Thus, at this point, the collector 150_1 has a weight and a characterization of a deposit (e.g., aluminum, plastic, glass). This information is sent over network 106 to the recycle management module 142. The user is credited for the deposit. This credit can be reflected on screen 206 of the collector and on a output device 112 on user device 102_1.

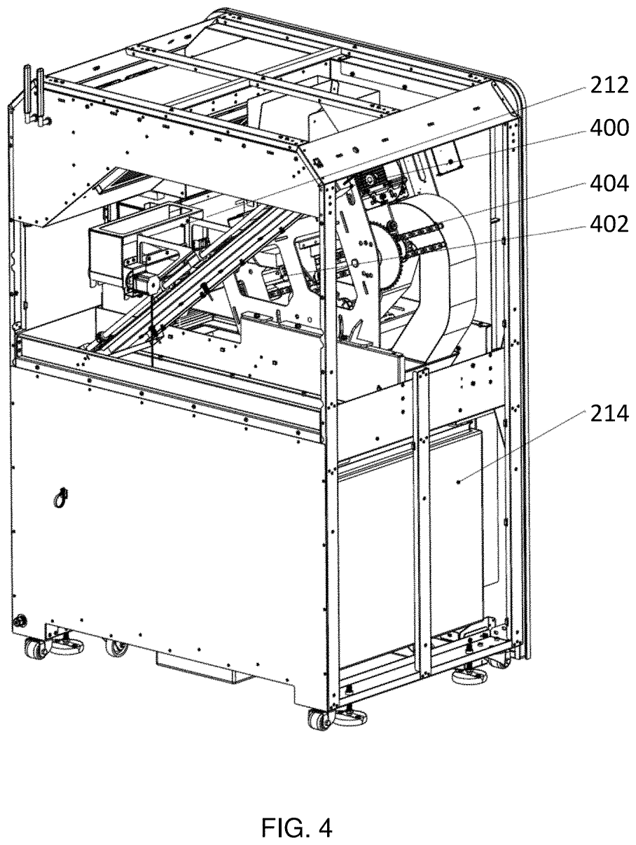

The deposit is then transferred from the imager 300 to the carriage 304. The carriage 304 moves the deposit to one of two locations: glass is deposited directly into the deposit bin 214 bypassing the crusher 212. If the deposit is an aluminum can or a plastic bottle, the carriage 304 transports the container to the top of the crusher, shown as region 400 in FIG. 4. The crusher 212 incorporates sorting of the aluminum deposits 402 and plastic 404 after they have been crushed. All accepted containers end up in the collection bin 214 in different bags segregated by type of material.

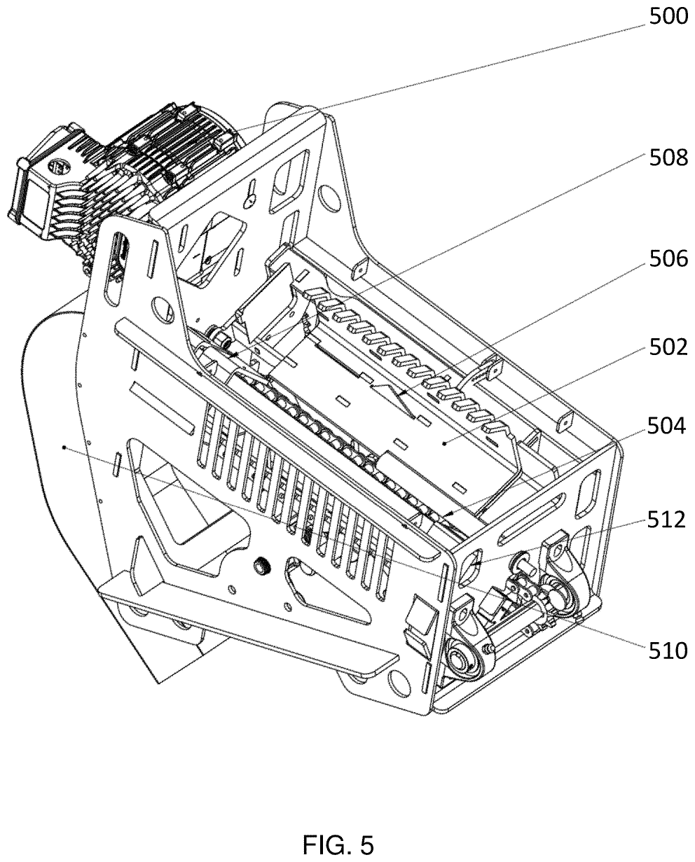

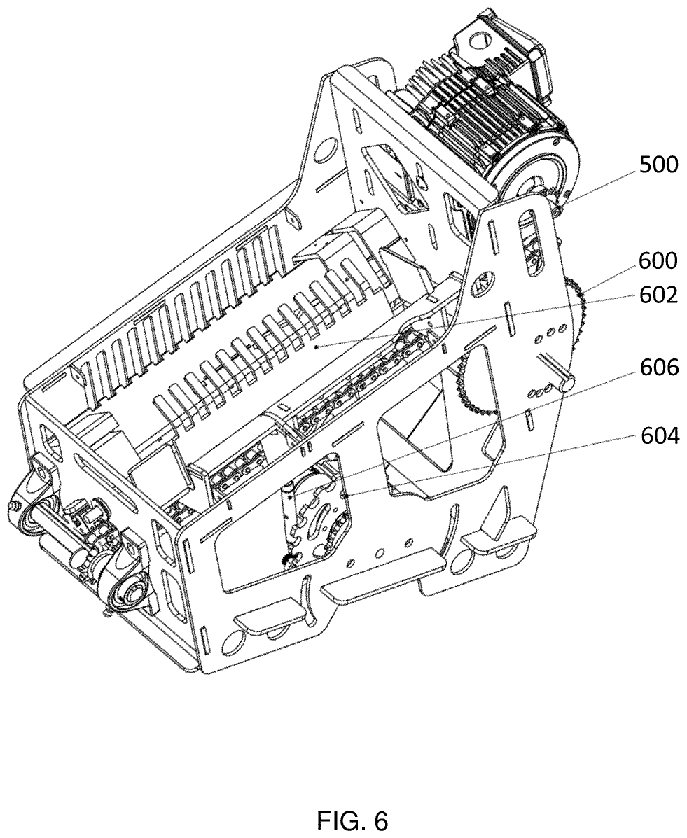

FIGS. 5 and 6 show how the crusher operates. The crusher is driven from a single motor 500 that drives a radial crushing arm 502 and a piston 504 that crushes the containers axially. The motor 500 uses blade 506 to pierce the container to make it easier to compress. The container is then crushed radially. After being crushed radially, motor 500 drives the piston 504 to crush the containers axially. All containers are crushed into an approximately 3.5″×3.5″ square cross-sectional area. Aluminum containers experience a reduction in volume of approximately 85%. Plastic containers experience a reduction in volume of 60-75%. These volume reductions provide for a capacity in storage 214 of up to 1500 user deposits.

When plastic containers are crushed, the piston 504 starts near the bottom of the crusher and the bottles are crushed up to the plastic exit 508. After plastic bottles exit the crusher, they are held from reentering the crusher with one-way blades and are directed into the material storage bin 214 with a chute 510. Aluminum cans enter the crusher the same way but for an aluminum cycle the piston 504 starts higher up in the crusher and crushes bottles down to the aluminum exit 512.

FIG. 6 shows that the power from the motor 500 is transferred by a chain around the idler sprocket 600 that moves the piston (504 in FIG. 5). The chain goes around the radial close drive sprocket 604. A clutch allows the radial close shaft to engage/disengage from the drive motor to open/close the radial crushing arm 602, which is connected to the radial close sprocket with a link 606 that locks into an over center position during crushing.

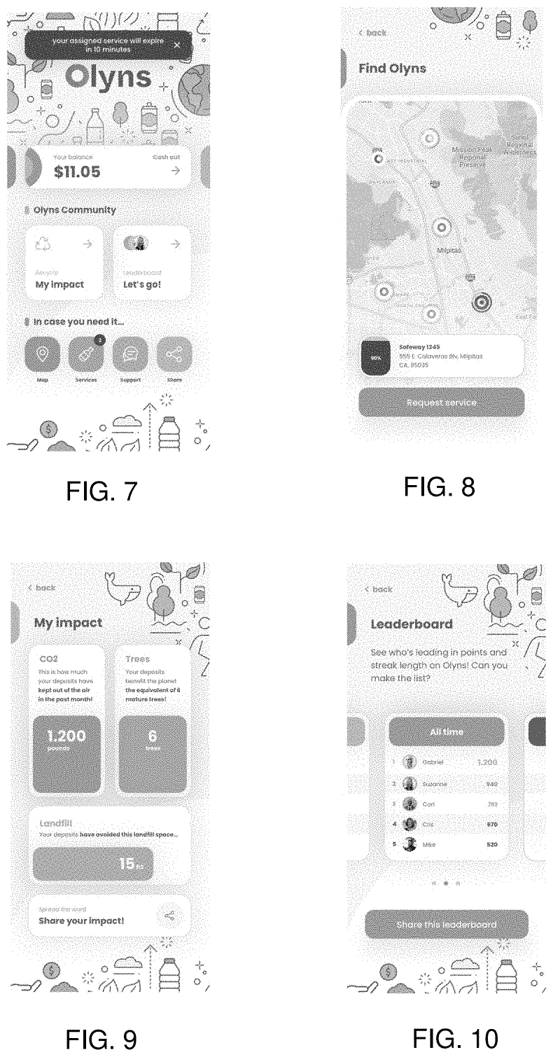

The recycle management module 142 includes instructions executed by processor 130 to communicate with user machines 102_1 through 102_N and collector machines 150_1 through 150_N. The recycle management module 142 provides user interfaces to user machines 102_1 through 102_N. For example, FIG. 7 illustrates a landing page that informs a user about credits earned from deposits and navigation tools through the application. Embodiments of the invention include an application that allows a user to access a collector via NFC, account management, deposit and credit tracking, leaderboards, impact tracking, information on collector locations and prompts to sign up to service a collector.

FIG. 8 illustrates an interface displaying the location of different collectors in a geographic region. The interface includes a prompt that allows a user to request to service a collector. The service may include emptying bins and receiving credit for such activity. This interface also allows users to see the current operational status of the collectors 150_1 to 150_N.

FIG. 9 illustrates an interface giving various measures of environmental impact, such as reduced CO2, equivalent tree contributions and landfill impact. The interface also allows a user to share such information in a social network.

FIG. 10 illustrates a leader board characterizing achievements of different individuals in a social network of like-minded conservationists. Thus, the application 122 uses gamification techniques to incentivize users to recycle more.

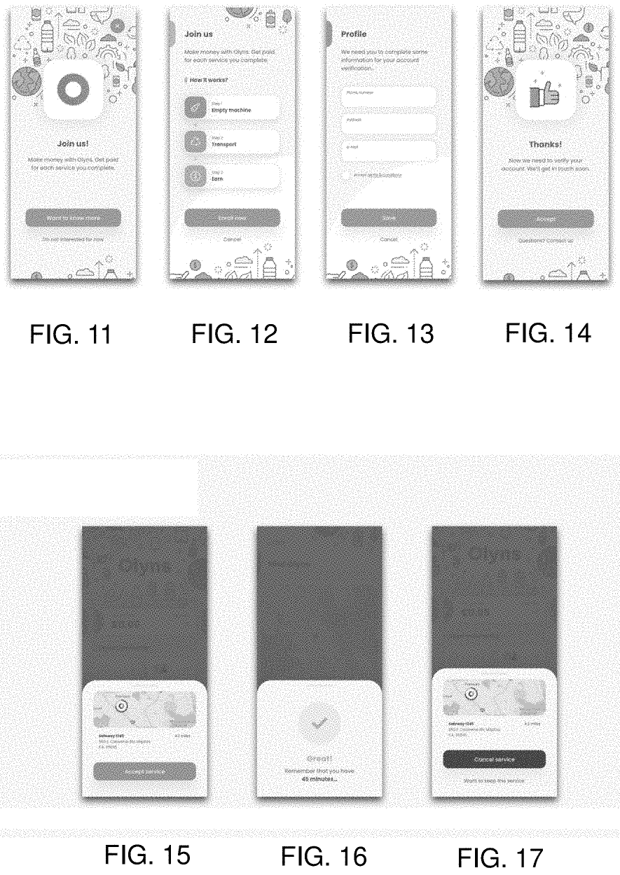

FIG. 11 shows a user interface prompting a user to join a network of individuals servicing collectors. FIG. 12 illustrates an interface that provides information on activities to empty a collector, transport the contents to a recycle venue and information on earnings from such activities. FIG. 13 illustrates prompts for personal information from a service provider. FIG. 14 illustrates a user interface to complete the enrollment process. User interfaces of FIGS. 11-14 are supplied on user devices 102_1 through 102_N using NFC 216 or recycle management module 142. These interfaces enable independent contractors to service collectors 150_1 through 150_N.

FIG. 15 illustrates a user interface that offers an opportunity to service a specific collector. If a user accepts the task, the user receives the confirmation interface shown in FIG. 16. The user can subsequently decline the task via the user interface of FIG. 17.

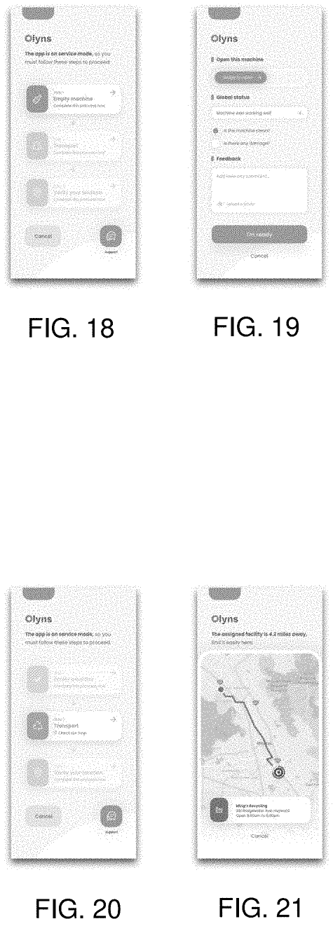

FIG. 18 illustrates an interface to assist a service provider in an operation to empty a collector. The user presses the prompt to empty a machine. In one embodiment, the user captures an image of a QR label on each bag removed from bin 214. The QR code is transmitted to recycle management module 142 to maintain a trace trail. FIG. 19 illustrates an interface to instruct the user to open the machine. For example, user device 102_1 may communicate with the collector using NFC 216 to open the machine.

FIG. 20 illustrates an interface to instruct a user where to transport contents from a collector. FIG. 21 illustrates a map to the destination and provides a distance to the destination.

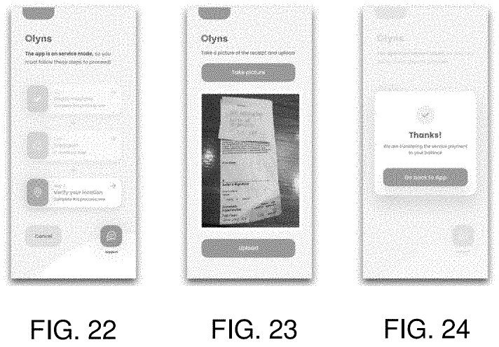

FIG. 22 prompts a user to verify a location. FIG. 23 prompts a user to take a picture of a receipt for the deposited material. FIG. 24 is an interface showing completion of a transaction.

The disclosed system provides a closely coupled virtual experience and physical deposit machine. The collector machines 150_1 through 150_N and the user machines 102_1 through 102_N work together to create a unified experience addressing the challenges of convenience as well as incentive. The application of community, impact, and gamification drive consumer green behavior. A large interactive display 204 is integrated into a recycling (reverse vending) machine. The reverse vending unit 150_1 allows for alternative business models for funding recyclables and provides a powerful tool for growing awareness.

The invention provides bottle segregation and densification in a small footprint machine for interior and exterior retail locations. The image recognition ensures a pure collection of PET plastic, aluminum, or glass and applies densification to compact bottles even if caps are present.

There is support for a gig worker servicing workflow through a tailored app workflow and hardware optimized for such operation. The collectors were designed with serviceability access in mind such as the front slide design, keyless access, and the collection bin on casters that can be wheeled out to a car. A completely touchless end user experience allows users to sign in, make deposits, and cash out. A set of app and backend tools allow for the tracking and accounting of deposited materials to satisfy Bottle Bill regulatory requirements. Bags of material are labeled with unique QR identifiers which are tied to the data in the backend through the app. The system relies upon AI for deposit recognition instead of existing solutions that rely on barcode reading. The AI based approach provides for greater flexibility and hardware simplicity. The entire front of the collector is a single sheet of scratch resistant acrylic or tempered glass minimizing the effort to maintain cleanliness and sanitary operation.

The recycle management module 142 provides connectivity to a community.

The user module 122 is configured such that as a user approaches a collector, the user is identified by proximity to an iOS or Android device via near field communications. Once the user is identified, the user may make deposits and these deposits are credited to the user account. AI powered image recognition identifies deposited containers. In one embodiment, the collectors rely on advanced neural network image recognition to classify user deposits. The collectors are equipped with sensors that communicate up to the minute status via the Internet of Things. Constant remote system monitoring is possible from this data being reported to the recycle management module 142.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A beverage container recycling system, comprising:
a housing with an advertising display, a user feedback display and a deposit opening;
an imaging region connected to the deposit opening, the imaging region having a camera to take an image of a deposited beverage container;
a processor, network interface circuit and memory associated with the housing, the memory storing instructions executed by the processor to analyze the image of the deposited beverage container to characterize the deposited beverage container as one of glass, aluminum or plastic;
a carriage to directly deposit a glass beverage container in a glass bin, the carriage directing aluminum and plastic beverage containers to a crusher with a blade to pierce aluminum and plastic beverage containers prior to compaction, the crusher selectively directing compacted beverage containers to a plastic bin and an aluminum bin;
the memory storing instructions executed by the processor to maintain a count of deposited beverage containers and communicate the count of deposited beverage containers to the network interface circuit for routing to a networked machine.

2. The beverage container recycling system of claim 1 wherein the instructions executed by the processor to analyze the image implement artificial intelligence image recognition.

3. The beverage container recycling system of claim 1 wherein the housing comprises five aluminum sides and a front panel formed of acrylic.

4. The beverage container recycling system of claim 1 wherein the housing hosts a near field communication reader.

5. The beverage container recycling system of claim 1 wherein the deposit opening has visual feedback of system status.

6. The beverage container recycling system of claim 1 in combination with the networked machine implemented with a recycle management module.

7. The beverage container recycling system of claim 6 in combination with user machines executing a recycling management application operative with the recycle management module.

8. The beverage container recycling system of claim 7 wherein the recycling management application displays user credits.

9. The beverage container recycling system of claim 7 wherein the recycling management application supplies user environmental impact data.

10. The beverage container recycling system of claim 7 wherein the recycling management application supplies competitive user data.

11. The beverage container recycling system of claim 7 wherein the recycling management application supplies service work instructions.

12. The beverage container recycling system of claim 1 wherein the glass bin, the plastic bin and the aluminum bin are each lined with a removable bag with a unique scannable code.

13. The beverage container recycling system of claim 1 wherein the crusher performs an initial radial crush and a subsequent axial crush of the deposited beverage container.
